(19) United States
(12) Patent Application Publication
(10) Pub. No.: US 2007/0165348 A1
(43) Pub. Date: Jul. 19, 2007

(54) CIRCUIT PROTECTION

(75) Inventors: Paul D. Nelson, Martinsville, IN (US); Robert L. Hancock, Lafayette, IN (US); Steven W. Lewis, Lafayette, IN (US)

Correspondence Address: TREXLER, BUSHNELL, GIANGIORGI,;BLACKSTONE & MARR, LTD., 105 WEST ADAMS STREET, SUITE 3600, CHICAGO, IL, 60603, US

(73) Assignee: WABASH NATIONAL, L.P., Lafayette, IN (US)

(21) Appl. No.: 11/561,608

(22) Filed: Nov. 20, 2006

Related U.S. Application Data
(60) Provisional application No. 60/760,019, filed on Jan. 18, 2006.

(51) Int. Cl. H02H 3/08

(52) U.S. Cl. 361/93.1

(57) ABSTRACT

A circuit which is configured for connection between a voltage source and a load, and which is configured to function as an automatic, re-settable fuse with regard to providing current to the load. The circuit includes a switch and sensor, such as a field effect transistor (FET), which is connected to the voltage source and the load and which is configured to selectively provide current to the load, depending on whether an overload condition exists. There is circuitry in communication with the FET which is configured to periodically send pulses to the FET in an attempt to re-set the switch and sensor during an overload condition. The circuit is configured to stop providing current to the load during an overload condition, but is configured to provide current to the load upon the overload condition being rectified. The circuitry which is in communication with the field effect transistor and which is configured to periodically send pulses thereto includes a timing circuit and an oscillator. Also included is a circuit speed controller which is configured to control how often the pulses are provided to field effect transistor.

### RELATED APPLICATION (PRIORITY CLAIM)

This application claims the benefit of U.S. Provisional Application Ser. No. 60/760,019, filed Jan. 18, 2006, which is hereby incorporated herein by reference in its entirety.

### BACKGROUND OF THE INVENTION

Fuses are used in electrical and electronic circuit protection. Typically, the fuse opens in response to a metallic element in the fuse melting due to heating effects when a certain current level is reached, to thus create an “open” in protected circuit, thereby preventing a short-circuit from damaging the protected components in the circuit. Some fuses return to normal when cooled (thus are automatic resettable), or by a manually resettable device. The conventional automatic resettable fuse does work, but for a limited number of cycles and thus needs to eventually be replaced.

### SUMMARY OF THE INVENTION

An embodiment of the present invention provides a circuit which operates as an auitomatic resettable high-speed fuse. The circuit requires a few economical components, resets itself after opening, and does not require a special current-sense resistor.

### BRIEF DESCRIPTION OF THE DRAWINGS

The organization and manner of the structure and operation of the invention, together with further objects and advantages thereof, may best be understood by reference to the following description taken in connection with the accompanying drawings wherein like reference numerals identify like elements in which:

FIG. 1 is a diagram of a circuit which is in accordance with an embodiment of the present invention, showing some of the components in block diagram form; and

FIG. 2 is a diagram similar to FIG. 1, but showing specific components of the circuit in more detail.

### DETAILED DESCRIPTION OF THE PREFERRED EMBODIMENT

While the invention may be susceptible to embodiment in different forms, there is shown in the drawings, and herein will be described in detail, a specific embodiment with the understanding that the present disclosure is to be considered an exemplification of the principles of the invention, and is not intended to limit the invention to that as illustrated and described herein.

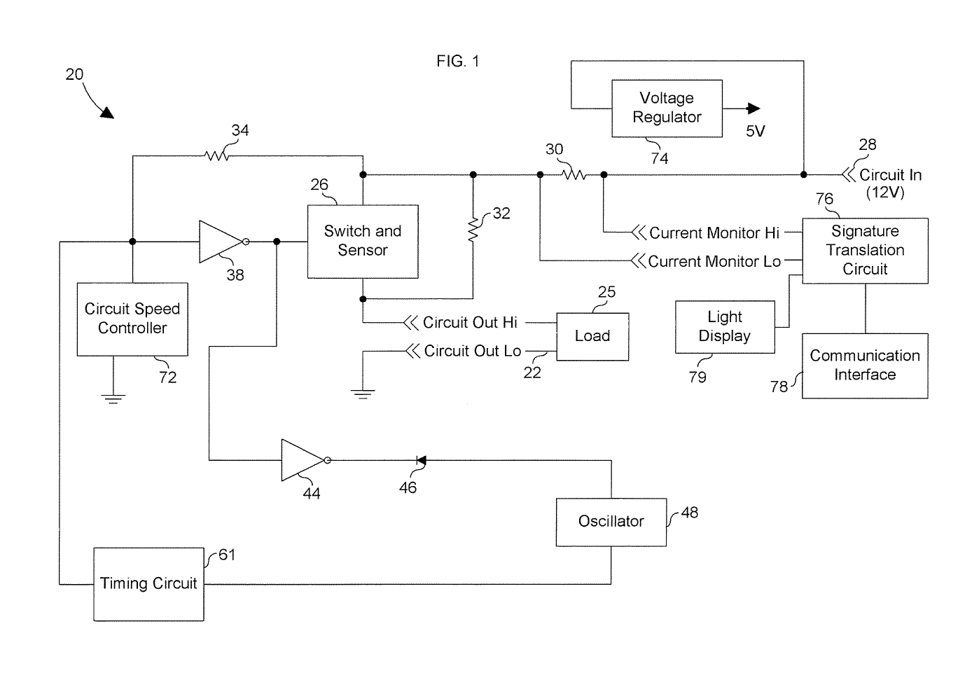

FIG. 1 illustrates a circuit 20 which is in accordance with an embodiment of the present invention. The circuit 20 is configured to operate as an automatic, resettable high-speed fuse. The circuit 20 requires a few economical components, resets itself after opening, and does not require a special current-sense resistor. The circuit 20 is preferably provided in a seven-way connector (not shown) of a trailer, such as the one shown in U.S. Pat. No. 6,450,833, which is concurrently owned by the assignee of the present provisional application. When used in the seven-way connector of the trailer, the circuit 20 is provided on six of the seven pins of the seven-way connector (the remaining pin being coupled to ground). The circuit 20 allows for the detection of an overload condition, such as a short circuit in the cabling 22, for example, connected between the seven-way connector and a grounded load 25 (for example, the lights of the trailer or the ABS system of the trailer).

The circuit 20 includes a switch and sensor 26 which is configured to selectively provide current to a load 25, depending on whether a short circuit condition exists, which will be described in more detail hereinbelow. The circuit 20 also includes an oscillator 48 and timing circuit 61 which are configured to become operative during a short circuit condition and periodically send pulses to the switch and sensor 26. The circuit 20 also includes a circuit speed controller 72 which is configured to effectively control how often the pulses are provided to the switch and sensor 26, and a voltage regulator 74 which is configured to regulate and provide voltage to certain components of the circuit 20, which will be described in more detail hereinbelow. The circuit 20 also includes a signature translation circuit 76 which is configured to generate a current signature which is used by a communication interface 78 and/or a light display 79, thereby providing a perceivable indication of the absence/presence of a short circuit condition.

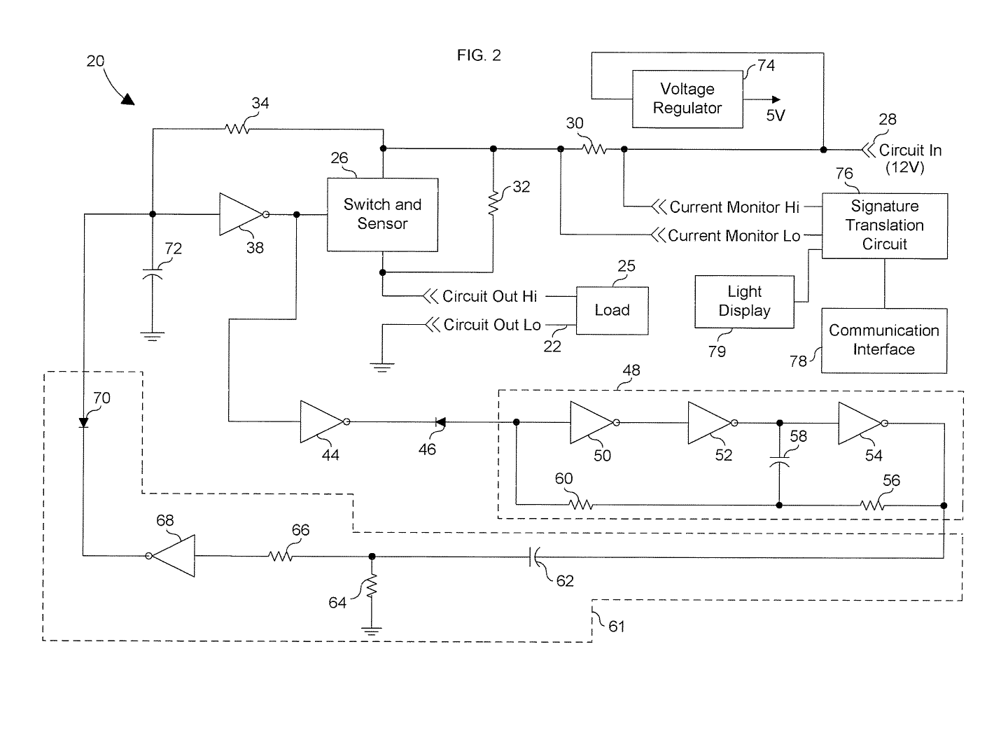

FIG. 2 shows the circuit 20 in more detail. As shown, the switch and sensor 26 may consist of a field effect transistor (FET) 26 which is configured to operate as a switch and as a sense resistor to control current to the load 25. FET 26 may be an IRF640 integrated circuit (“IC”) manufactured by International Rectifier and others.

Voltage and current are supplied to the circuit 20 by the “circuit in” 28 from the cab of the trailer through the seven-way connector. The applied voltage to the circuit 20, is for example, 12 volts.

A resistor 30 is connected to the “circuit in” 28. Resistors 32, 34 are connected to resistor 30. The drain 36 of FET 26 is connected to resistor 30. Resistor 34 is connected to the input of inverter 38 (one of a group of inverters in an IC package, commonly referred to as “CD4049UB”), and the output of the inverter 38 is connected to the gate 40 of FET 26. The source 42 of FET 26 is connected to resistor 32 and to the load 25.

An input of inverter 44 (of IC CD4049UB) is connected to the output of inverter 38 between inverter 38 and the gate 40 of FET 26. The output of inverter 44 is applied to a diode 46 which, in turn, is connected to the input of the oscillator 48. As shown in FIG. 2, the oscillator 48 may consist of three inverters 50, 52, 54 in series, two resistors 56, 60, and a capacitor 58. In addition to being connected to resistor 56, the output of inverter 54 (and effectively the output of the oscillator 48) is connected to the timing circuit 61.

As shown in FIG. 2, the timing circuit 61 may consist of a capacitor 62, resistors 64, 66, inverter 68 and diode 70. Capacitor 62 is connected to the output of the oscillator 48 and to a grounded resistor 64. Capacitor 62 is also connected to resistor 66, and resistor 66 is connected to the input of inverter 68. The output of inverter 68 is connected to diode 70, and diode 70 is connected to the input of inverter 38. Diode 70 is also connected to the circuit speed controller 72, which as shown in FIG. 2 may consist of a grounded capacitor 72 which is also connected to resistor 34 and to the input of inverter 38.

The “circuit in” 28 is also connected to the input of the voltage regulator 74 (IC MC7805/TO, for example). The output of the voltage regulator 74 is connected to the inverter package (IC CD4049UB) which includes inverters 38, 44, 50, 52, 54, 68 to supply power (typically 5 volts) to same in a conventional mariner. Inverters 38, 44, 50, 52, 54, 68 are grounded in a conventional manner.

A voltage drop is measured across resistor 30 for use by the signature translation circuit 76 in generating a current signature, which is used by a communication interface 78 in the cab of the trailer and/or on a light display 79 on the trailer. The signature translation circuit 76 is preferably controlled by a microcontroller which has a memory built into it. A suitable microcontroller is sold by Freescale under Model No. HCS08.

Now that the structure of the circuit 20 has been described, two operating conditions will be described, namely, a non-short condition and a short-circuit condition.

In a non-overload condition such as during a non-short condition, the cable 22 and the load 25, for example the cable and associated trailer lights, are functioning normally. In this condition, current flows through the resistor 30, causing a lower voltage to be applied to the drain 36 of FET 26. Current also flows through resistor 34 to apply a logical low voltage signal (“LOW”) to the input of inverter 38. A logical high voltage signal (“HIGH”) is thus created on the output inverter 3 8 and applied to the gate 40 of the FET 42. A HIGH on the gate 40 of FET 26 causes the flow of current through the FET 26 and the load 25 to be at normal (non-short) operating levels.

The HIGH is also applied to the input of inverter 44, thereby creating a LOW on its output. Diode 46 effectively allows this LOW to pass to the input of inverter 50, thereby turning off the oscillator 48 and disabling the timing circuit 61. As such, during normal operating conditions, the switch and sensor 26 (i.e., the FET 26 shown in FIG. 2) causes the current to flow to the load 25, and the oscillator 48 and timing circuit 61 are effectively not operational.

In an overload condition such as when there is a short-circuit condition, the load 25, for example the lights, are not functioning normally because of, for example, a short-circuit in the cabling 22 between the seven-way connector and the load 25. In this condition, an excessive current flows through the resistor 30 as the current flows to ground instead of through the load 25, causing a voltage to be applied the drain 36 of FET 26 which is higher than the voltage applied to the drain 36 of FET 26 in the non-short condition. The FET 26 acts as a voltage divider causing a higher voltage to be applied to resistor 34. As a result, a HIGH is applied to the input of inverter 38. The capacitor 72 also charges as a result of this increased voltage. A LOW is thus created on the output of inverter 38 and applied to the gate 40 of FET 42. A LOW on the gate 40 of FET 26 effectively stops the flow of current through the FET 26 and, as a result, effectively stops current being supplied to the load 25.

The present circuit 20 also provides for a constant checking to verify that the short-circuit is still occurring. Once the short-circuit has been rectified, the circuit 20 automatically resets the FET 26 to allow current to flow therethrough such that current is supplied to the load 25.

To perform the check, the LOW on the output of inverter 38 is applied to the input of inverter 44. The inverter 44 then creates a HIGH on the output and applies the HIGH to diode 46.

The diode 46 blocks the HIGH, thereby enabling oscillator 48 and timing circuit 61. Oscillator 48 periodically (e.g., every few tenths of a second) sends a pulse to inverter 38 through inverter 68, attempting to reset FET 26. If the short-circuit persists, FET 26 “blows” again; this process takes approximately 25 μs, for example. If the short-circuit does not persist, the current rises in 25 μs.

Inverter 50 converts the LOW on its input to a HIGH on its output. The HIGH is applied to the input of inverter 52, and the inverter 52 converts the HIGH to a LOW, supplying the LOW to the input of inverter 54, which converts the LOW back to a HIGH.

This HIGH is applied to capacitor 62 which induces a HIGH on the input of inverter 68. Inverter 68 converts the signal to a LOW and applies the LOW to diode 70. As a result of the LOW passed by diode 70, a LOW is generated by capacitor 72 for a predetermined amount of time as the capacitor 72 discharges. This LOW is applied to the input of inverter 38, and the inverter 38 creates a HIGH and applies it to the gate 40 of the FET 42. A HIGH on the gate 40 of FET 26 allows for the flow of current through the FET 26 and for current to be supplied to the load 25. If the short-circuit persists, an excessive current flows through the resistor 30 as the current flows to ground instead of through the load 25, causing a voltage to be applied to the drain 36 of FET 26 which is higher than the voltage applied to the drain 36 of FET 26 in the non-short condition. The FET 26 acts as a voltage divider causing a higher voltage to be applied to resistor 34. As a result, a HIGH is applied to the input of inverter 38. The capacitor 72 also recharges as a result of this increased voltage. A LOW is thus created on the output of inverter 38 and applied to the gate 40 of FET 42. A LOW on the gate 40 of FET 26 effectively stops the flow of current through the FET 26 and, as a result, effectively stops current being supplied to the load 25.

The HIGH on the output of inverter 54 is also is fed back to the input of inverter 50, and the inverter 50 converts the HIGH to a LOW. The LOW is applied to the input of inverter 52, which converts the LOW to a HIGH. The HIGH is applied to the input of inverter 54, which converts the HIGH to a LOW. The LOW does not induce a HIGH to be passed by capacitor 62. The LOW on the output of inverter 54 is fed back to the input of inverter 50, thereby repeating the cycle discussed above. Therefore, pulses of HIGH are sent to capacitor 62 so that the check on FET 26 can be repeatedly performed.

As a result, when FET 26 is closed, i.e., the fuse “blows”, the circuit 20 periodically (e.g., every few tenths of a second) sends a signal enabling the FET 26, attempting to reset the FET 26. If the short persists, the FET 26 blows again; this process can take microseconds, for example. If the short does not persist, the circuit 20 enables the FET 26 and returns the FET 26 to the normal condition.

The speed of the circuit 20 can be tuned by modifying capacitor 72, which low-pass filters the signal from the drain 36 of FET 26.

Because of the fast response, no heating effects take place, so persistent shorts can be tolerated continuously without damage to the system. An indicator (identified with reference numerals 78 and 79, and discussed above) can be provided, therefore, enabling an operator to quickly identify a malfunctioning circuit. This identification also aids in the determination that the circuit 20 having the short-circuit has been rectified, such as when the communication interface 78 indicates that the short-circuit condition no longer exists or when the light display 79 is no longer illuminated.

The exact current flowing through the system can be monitored via resistor 30. This provides for the ability to establish a current signature. With such a current signature, metrics can used to assist its prognostics, trend analysis (current change over time due to corrosion, for example), and maintenance assistance that can be translated and available to both driver and remote information via signature translation circuit 76 and communication interface 78.

With regard to what exact elements can used in the implementation of what is shown in FIGS. 1 and 2, capacitor 58 could be a 10 μF, 25V tantium capacitor, capacitor 62 could be a 1.5 nF, 100V ceramic capacitor, and capacitor 72 could be a 0.1 μF, 100V ceramic capacitor, all of which are made by Kemet. Each of diodes 46 and 70 could be a IN4148 general purpose diode, and as discussed above FET 26 could be a IRF640/TO MOSFET made by International Rectifier. Each of resistors 34, 64 and 66 could be a 100 Kohm, ⅛ Watt resistor, each of resistors 56, 60 could be a 1 Mohm, ⅛ Watt resistor, and resistor 32 could be a 10 Kohm, ⅛ Watt resistor, all of which are made by Yageo.

While a preferred embodiment of the present invention is shown and described, it is envisioned that those skilled in the art may devise various modifications of the present invention. For example, while specific discreet elements are shown in FIGS. 1 and 2, it should be understood that different elements can be used, or the circuit can be implemented in more of a microprocessor-type implementation.

What is claimed is:

1. A circuit configured for connection between a voltage source and a load and configured to function as an automatic, re-settable fuse with regard to providing current to the load, said circuit comprising: a switch and sensor which is connected to the voltage source and the load and which is configured to selectively provide current to the load, depending on whether an overload condition exists; circuitry which is in communication with the switch and sensor and which is configured to periodically send pulses to the switch and sensor in an attempt to re-set the switch and sensor during an overload condition, wherein said circuit is configured to stop providing current to the load during an overload condition and is configured to provide current to the load upon the overload condition being rectified.

2. The circuit as recited in claim 1, wherein the switch and sensor comprises a field effect transistor.

3. The circuit as recited in claim 1, wherein the circuitry which is in communication with the switch and sensor and which is configured to periodically send pulses to the switch and sensor comprises a timing circuit and an oscillator which is connected to the input of the timing circuit.

4. The circuit as recited in claim 3, wherein the circuit is configured such that the timing circuit and oscillator do not operate to send pulses to the switch and sensor when an overload condition does not exist.

5. The circuit as recited in claim 1, wherein the switch and sensor comprises a field effect transistor, wherein the circuitry which is in communication with the field effect transistor and which is configured to periodically send pulses to the field effect transistor comprises a timing circuit and an oscillator which is connected to the input of the timing circuit, wherein the circuit is configured such that the timing circuit and oscillator do not operate to send pulses to the field effect transistor when an overload condition does not exist.

6. The circuit as recited in claim 1, further comprising a circuit speed controller which is configured to control how often the pulses from the circuitry are provided to the switch and sensor.

7. The circuit as recited in claim 6, wherein the circuit speed controller is connected to an output of the timing circuit.

8. The circuit as recited in claim 6, wherein the circuit speed controller comprises a capacitor.

9. The circuit as recited in claim 7, further comprising an inverter, wherein the switch and sensor comprises a field effect transistor, wherein the inverter is disposed between the output of the timing circuit and the field effect transistor.

10. The circuit as recited in claim 1, further comprising a signature translation circuit which is disposed between the voltage source and the switch and sensor.

11. The circuit as recited in claim 10, further comprising a communication interface in communication with the signature translation circuit.

12. The circuit as recited in claim 10, further comprising a light display in communication with signature translation circuit.

13. The circuit as recited in claim 10, further comprising a resistor which is disposed between connection points of the signature translation circuit.

14. The circuit as recited in claim 1, further comprising a voltage regulator configured to provide voltage to components of the circuit.

15. The circuit as recited in claim 1, wherein the switch and sensor comprises a field effect transistor and wherein the circuitry which is in communication with the switch and sensor and which is configured to periodically send pulses to the switch and sensor comprises a timing circuit and an oscillator which is connected to the input of the timing circuit, further comprising a diode which is connected to an input of the oscillator and is configured to selectively apply a signal to the oscillator, thereby rendering the oscillator and timing circuit operative whereupon the timing circuit periodically sends pulses to the field effect transistor.

16. The circuit as recited in claim 15, further comprising a circuit speed controller which is connected to an output of the timing circuit and is configured to control how often the pulses from the timing circuit are provided to the field effect transistor.

17. The circuit as recited in claim 16, wherein the circuit speed controller comprises a capacitor.

18. The circuit as recited in claim 16, further comprising an inverter disposed between the output of the timing circuit and the field effect transistor.

19. The circuit as recited in claim 1, wherein the switch and sensor comprises a field effect transistor having its source connected to the load and its drain connected to the voltage source.
